(19) United States
(12) Patent Application Publication
(10) Pub. No.: US 2006/0256593 A1
(43) Pub. Date: Nov. 16, 2006

(54) Voltage controller with true RMS indicator

(75) Inventor: Martin Pierson, Howell, MI (US)

Correspondence Address: BRIAN M BERLINER, ESQ;O'MELVENY & MYERS, LLP, 400 SOUTH HOPE STREET, LOS ANGELES, CA, 90071-2899, US

(73) Assignee: LIONEL L.L.C.

(21) Appl. No.: 11/128,057

(22) Filed: May 11, 2005

(51) Int. Cl. H02M 7/48

(52) U.S. Cl. 363/71

(57) ABSTRACT

A power controller for a model vehicle layout provides output AC power in response to user input. A sensor circuit and indicating device, such as a digital display screen, an LED bank, or a dial indicator, are integrated with the power controller in an assembly. The sensor circuit provides a signal proportional to an RMS value of the AC output power. The indicating device receives the sensor signal and provides a display indicating the RMS value.

### BACKGROUND OF THE INVENTION

1. Field of the Invention

The present invention relates to an AC power controller used for supplying AC power to toys and model vehicles, such as to model trains; and more particularly, to a power supply controller with a voltage readout or indicator.

2. Description of Related Art

Model vehicles, such as model trains or the like, are often constructed to operate using a low voltage AC source, such as between about 0-18 VAC. Household AC power is usually in the range of 110-120 VAC or 220-240 VAC, and so a transformer is used to transform the higher power to a lower power that is supplied to a conductive model train track or other distribution circuit for delivery to a model vehicle. Model vehicle layouts may also include a voltage controller in association with the transformer. The voltage controller may be used to vary the voltage of AC power supplied to the model train layout, for purposes such as controlling model vehicle speed. For example, a “ZW Controller” is available from Lionel, LLC, with offices in Chesterfield, Mich. The ZW Controller permits a user to set a maximum track voltage using a rotating handle. The ZW Controller also includes wireless communications circuitry for communicating with a handheld remote control, and may be configured to control voltage output in response to commands from the handheld controller.

Actual voltage output from a power controller is of interest to model train enthusiasts. Accordingly, some power controllers may be equipped with a voltage indicator, such as a digital readout, dial indicator, or LED bank, responsive to average voltage output from the power controller. Such indicators generally provide an indication of average AC voltage or current. While this is not the same as actual power, it should correspond to actual AC power for a regular waveform such as a sine wave, via a relationship known in the art. However, average AC power does not correspond to actual power for irregular waveforms. Also, some hobbyists may find a voltage indicator that differs from a true RMS power indicator to be confusing, such as when comparing an average value from a controller to a true RMS value from a voltmeter or multimeter. Accordingly, it is desired to provide a power controller for a model vehicle with a more accurate indicator of true power.

### SUMMARY OF THE INVENTION

The present invention provides a power controller for a model train, comprising power control circuitry, an indicating device such as a digital readout for indicating a measure of output power, and a sensor circuit for providing a signal corresponding to true RMS output. In an embodiment of the invention, the power controller outputs a regular AC waveform, such as a sine wave, and the sensor circuit comprises a voltage or current multiplier, that corrects a signal proportional to average AC output by a predetermined factor to provide a signal proportional to true RMS output over the output range of the controller. In an alternative embodiment, the sensor circuit is connected to an output of the power controller for supplying AC output power, and provides an output signal proportional to true RMS of the AC output power, regardless of whether the output power comprises a regular waveform. In both embodiments, the output from the sensor circuit is provided to any suitable indicator or user interface, which then provides a visual or audible indicator of current output power, in true RMS.

A more complete understanding of the power controller with true RMS indicator will be afforded to those skilled in the art, as well as a realization of additional advantages and objects thereof, by a consideration of the following detailed description of the preferred embodiment. Reference will be made to the appended sheets of drawings which will first be described briefly.

### BRIEF DESCRIPTION OF THE DRAWINGS

FIG. 1 is a block diagram showing an exemplary power controller with true RMS readout according to the invention.

FIG. 2 is a circuit diagram showing an exemplary sensor circuit for providing an output proportional to true RMS of an input waveform.

### DETAILED DESCRIPTION OF THE PREFERRED EMBODIMENT

The present invention provides a power controller in an assembly with a sensor circuit providing an signal indicative of RMS power output from the controller, and an indicator device for providing a visual or audible indicator of the RMS power. A power controller according to the invention should be beneficial to model vehicle enthusiasts and others who desire to provide power to a model layout at a controlled variable power level.

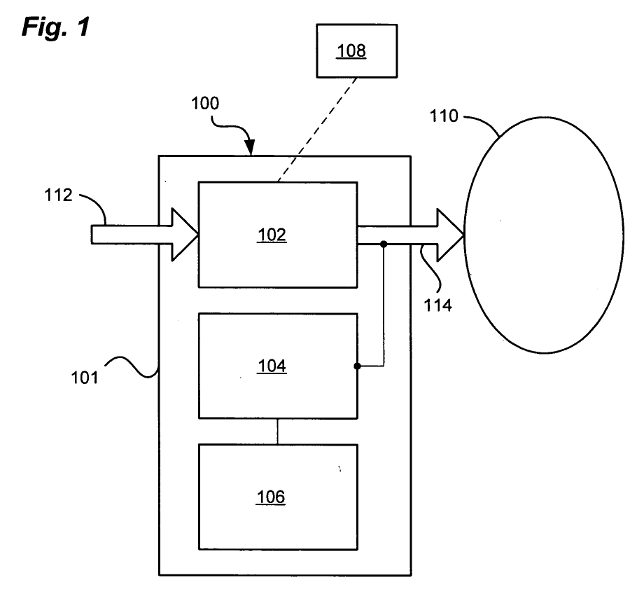

Referring to FIG. 1, a power controller 100 according to the invention may comprise a power control circuit 102, a sensor circuit 104, and an indicating device 106 in an assembly 101. In an embodiment of the invention, circuits 102, 104 and indicator 106 are provided in an integrated housing. Various suitable power control circuits 102 are known in the art, for example, a power control circuit as used in the Lionel ZW power controller.

Control circuit 102 should be adapted to receive an input power 112, such as a household AC voltage or reduced AC voltage from a transformer, and provide a variable output AC power 114 to a model layout 110. In an embodiment of the invention, the model layout comprises a model train track, and the output power is supplied to “neutral” and “hot” rails of a three-rail track. For example, variable AC power may be supplied in the range of 0-18 V RMS. The power control circuit 102 may further be adapted to control the level of output power 114 based on one or more control inputs, such as a control input from a handheld device 108 via a wireless or wired communication link. Various suitable power control circuits are known in the art, or may be developed by one of ordinary skill.

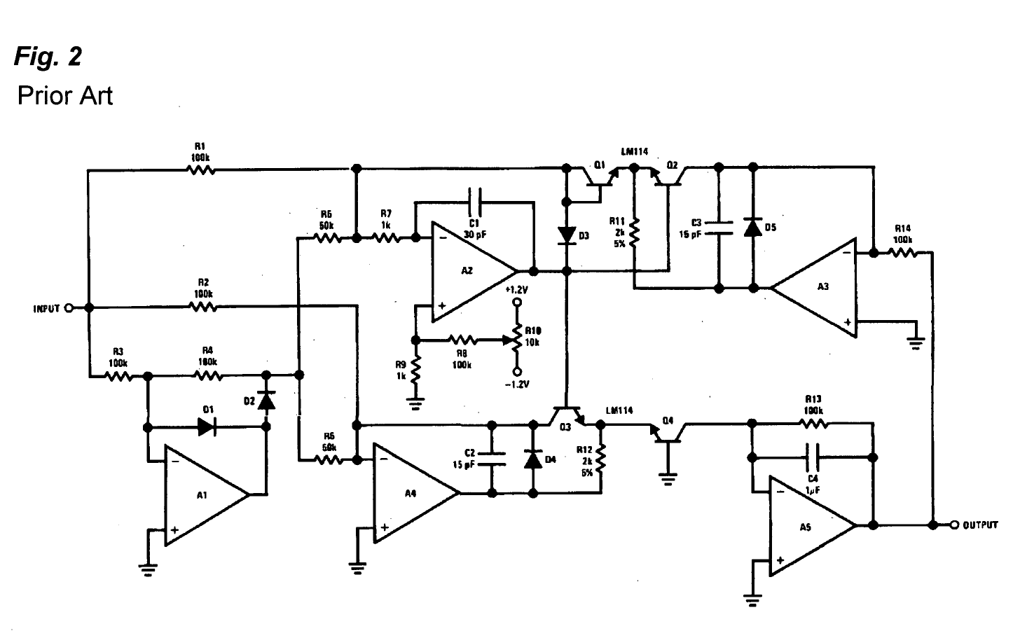

Sensor circuit 104 may comprise any suitable circuit for receiving an AC signal as input and providing an output signal proportional to the true RMS of the AC signal. The sensor circuit may be connected to an output of the power control circuit 102 for receiving the AC power 114. One suitable analog sensor circuit is described below in connection with FIG. 2. Other analog or digital sensor circuits are known in the art, or may be developed by one of ordinary skill, and may also be suitable. In embodiments wherein output signal 114 comprises a known regular waveform, a simpler circuit may suffice to provide an indication of RMS voltage. For example, a suitable circuit may comprise as little as one op-amp. The output signal may be an analog signal, for example a DC voltage proportional to the measured RMS voltage. In the alternative, a digital output signal may comprise a coded numeric value of the RMS voltage. In cases where the controller 102 comprises a digital device, it may be possible to incorporate circuit 104 in the same device, or in an adjacent digital device, to provide a digital output indicative of RMS voltage.

Indicator 106 may comprise any suitable indicating device, for example, a digital readout displaying a numeric value of the AC RMS voltage, based on a signal from sensor circuit 104. In the alternative, the indication device may comprise a dial or needle indicator that points to an analog voltage scale, thereby indicating an RMS voltage. Yet another alternative is to use a bank of LED's or small lamps, configured such that the number of illuminated lamps indicates RMS voltage. For example, a bank of 18 lamps could be used to indicate a voltage between 0 and 18 volts RMS, wherein an additional lamp is illuminated of each 1-volt increment in RMS voltage. Various other suitable indicating devices may be combined with the power controller and sensor circuit by one or ordinary skill.

FIG. 2 shows one suitable prior art analog sensor circuit that may be adapted to provide an analog output signal proportional to a true RMS of an input AC waveform. The input waveform may be a regular or irregular waveform. All operational amplifiers are LM118, and all diodes are IN914. All resistors are 1% unless otherwise indicated. The circuit is designed to operate using an input voltage of ±15 V. The circuit essentially comprises an absolute value circuit coupled to a one-quadrant multiplier/divider. Op-amp A1 is the absolute value amplifier, and provides a positive output to A2 and A4. Amplifiers A2 through A5 with transistors Q1 through Q4 provide a log multiplier/divider. The square of the input appears as the collector current of Q4. This is averaged by C4, providing a mean square output. The filtered output of Q4 is provided back to Q2 for continuous division to provide a true root mean square output. Further details concerning the foregoing circuit may be found in National Semiconductor Linear Brief 25, “True RMS Detector,” June 1973. Various other suitable analog or digital RMS sensor circuits are known in the art, or may be developed by one of ordinary skill.

Having thus described a preferred embodiment of the power controller with true RMS indicator, it should be apparent to those skilled in the art that certain advantages of the within system have been achieved. It should also be appreciated that various modifications, adaptations, and alternative embodiments thereof may be made within the scope and spirit of the present invention. For example, a power controller for model trains has been illustrated, but it should be apparent that the inventive concepts described above would be equally applicable to similar power controllers for other AC-powered toys. The invention is further defined by the following claims.

What is claimed is:

1. A power controller for a model vehicle layout, comprising:
a power control circuit adapted for receiving input AC power at a first voltage and providing an output AC power at a second voltage, wherein the second voltage is determined from a user input;
a sensor circuit connected to an output of the power control circuit and integrated with the power control circuit in an assembly, wherein the sensor circuit is adapted to provide an output signal indicating a true RMS of the output AC power; and
an indicating device connected to the sensor circuit and integrated with the sensor circuit in the assembly, the indicating device providing an indicator of the output signal.

2. The power controller of claim 1, wherein the indicating device comprises a digital display screen.

3. The power controller of claim 1, wherein the indicating device comprises a plurality of LED's arranged in an LED bank.

4. The power controller of claim 1, wherein the indicating device comprises a dial indicator.
